(19) United States
(12) Patent Application Publication
(10) Pub. No.: US 2025/0269730 A1
(43) Pub. Date: Aug. 28, 2025

(54) HIGH PERFORMANCE THREE MOTOR ELECTRIC DRIVE AXLE

(71) Applicant: FCA US LLC, Auburn Hills, MI (US)

(72) Inventors: Sandeep Makam, Rochester Hills, MI (US); Pradeep Attibele, Ann Arbor, MI (US); Donald F Schmanski, Howell, MI (US)

(21) Appl. No.: 18/589,896

(22) Filed: Feb. 28, 2024

(51) Int. Cl. B60L 15/20; B60K 1/02; B60K 7/00; B60K 17/04; B60L 7/10; B62D 11/00; B62D 11/04

(52) U.S. Cl. CPC B60L 15/20; B60K 1/02; B60K 7/0007; B60K 17/046; B60L 7/10; B60L 15/2036; B62D 11/003; B62D 11/04; B60K 2007/0061

(57) ABSTRACT

An electrified powertrain that generates and transfers drive torque to a driveline of an electrified vehicle including first and second drive wheels is provided. The electrified powertrain includes an electric drive module having a first, second and third electric motor, a first geartrain and a second geartrain. The first electric motor can have two first outputs. The second electric motor can have a second output. The third electric motor can have a third output. The first geartrain can include: a first planetary gear set having a first sun gear fixed for rotation with the second output, a first carrier, and a first ring gear fixed for rotation with one of the first outputs; and a first final gear reduction having a first final drive pinion fixed for rotation with the first carrier and a first final output that drives the first drive wheel.

### FIELD

The present application generally relates to electrified vehicles and, more particularly, to an electric drive axle configuration having three electric motors and two geartrains that cooperatively provide drive torque to drive wheels of the electrified vehicle.

### BACKGROUND

An electrified vehicle (hybrid electric, plug-in hybrid electric, range-extended electric, battery electric, etc.) includes at least one battery system and at least one electronic drive module having an electric motor and associated electric drive gearbox assembly. A power inverter module converts the direct current (DC) from the battery to alternating current (AC) used by the traction motor(s). Typically, the electrified vehicle would include a high voltage battery system and a low voltage (e.g., 12 volt) battery system. In such a configuration, the high voltage battery system is utilized to power at least one electric motor configured on the vehicle and to recharge the low voltage battery system via a direct current to direct current (DC-DC) convertor. The electric drive gearbox assembly can be configured in many ways to achieve various gear ratios for accessing during specific drive conditions. In some high-performance examples, however, it can be cost and time prohibitive to develop bespoke electric motors specifically suited to provide high output. Accordingly, while such electronic drive modules do work well for their intended purpose, there is a desire for improvement in the relevant art.

### SUMMARY

According to one example aspect of the invention, an electrified powertrain that generates and transfers drive torque to a driveline of an electrified vehicle including first and second drive wheels is provided. The electrified powertrain includes an electric drive module having a first, second and third electric motor, a first geartrain and a second geartrain. The first electric motor can have two first outputs. The second electric motor can have a second output. The third electric motor can have a third output. The first geartrain can include: a first planetary gear set having a first sun gear fixed for rotation with the second output, a first carrier, and a first ring gear fixed for rotation with one of the first outputs; and a first final gear reduction having a first final drive pinion fixed for rotation with the first carrier and a first final output that drives the first drive wheel. The second geartrain can include: a second planetary gear set having a second sun gear fixed for rotation with the third output, a second carrier, and a second ring gear fixed for rotation with the other of the first outputs; a second final gear reduction having a second final drive pinion fixed for rotation with the second carrier and a second final output that drives the second drive wheel.

In some implementations, the electrified powertrain includes a controller that controls operation of the first, second and third electric motors to alter drive torque to the driveline based on operating conditions.

In some implementations, the controller is configured to operate the electric drive module in a first straight line driving mode including: command only the first electric motor to operate in positive motor torque and positive motor speed.

In some implementations, the controller is configured to operate the electric drive module in a second straight line driving mode including: command only the second and third electric motors to operate in positive motor torque and positive motor speed.

In some implementations, the controller is configured to transition operation of the electric drive module between the first and second straight line driving mode based on operating conditions.

In additional aspects, the controller is configured to operate the electric drive module in a torque vectoring mode including: determine one of the first or second drive wheels slipping; and command the electric motor associated with the slipping drive wheel to operate at a reduced torque.

In additional features, the controller is configured to operate the electric drive module in a steering mode including: determine a steering input to a left direction; command the first and second electric motors to reduce speed; and command the third electric motor to increase speed.

In additional features, the controller is further configured to: determine a steering input to a right direction; command the first and third electric motors to reduce speed; and command the second electric motor to increase speed.

In other features, the controller is further configured to operate the electric drive module in a braking mode including: command the first, second and third motors to change operation from positive motor speed and positive motor torque to positive motor speed and negative motor torque.

In additional features, the controller is further configured to operate the electric drive module in a tank steer mode including: command the second motor to operate in positive motor speed and positive motor torque; command the third motor to operate in a negative motor speed and negative motor torque; and command the first motor to operate at zero speed.

According to other features, the first final drive pinion is floating on the second output shaft and the second final drive pinion is floating on the third output shaft.

According to other features, the first electric motor is positioned intermediate the second and third electric motors.

In other features, the first, second and third electric motors are constructed similarly.

In additional features, the first, second and third electric motors comprise 350 KW electric motors.

In other features, the first electric motor is constructed differently than the second and third electric motors.

According to another example aspect of the invention, an electrified powertrain that generates and transfers drive torque to a driveline of an electrified vehicle including first and second drive wheels is provided. The electrified powertrain includes an electric drive module having a first, second and third electric motor, a first geartrain and a second geartrain. The first electric motor can have two first outputs. The second electric motor can have a second output. The third electric motor can have a third output. The first geartrain can include: a first planetary gear set having a first sun gear fixed for rotation with one of the first outputs of the first electric motor, a first carrier, and a first ring gear fixed for rotation with the second output; and a first final gear reduction having a first final drive pinion fixed for rotation with the first carrier and a first final output that drives the first drive wheel. The second geartrain can include: a second planetary gear set having a second sun gear fixed for rotation with the other of the first outputs of the first electric motor, a second carrier, and a second ring gear fixed for rotation with the third output; a second final gear reduction having a second final drive pinion fixed for rotation with the second carrier and a second final output that drives the second drive wheel.

Further areas of applicability of the teachings of the present application will become apparent from the detailed description, claims and the drawings provided hereinafter, wherein like reference numerals refer to like features throughout the several views of the drawings. It should be understood that the detailed description, including disclosed embodiments and drawings referenced therein, are merely exemplary in nature intended for purposes of illustration only and are not intended to limit the scope of the present disclosure, its application or uses. Thus, variations that do not depart from the gist of the present application are intended to be within the scope of the present application.

### BRIEF DESCRIPTION OF THE DRAWINGS

FIG. 1 is a functional block diagram of an electrified vehicle having an electronic drive module according to various principles of the present application; and

FIG. 2 illustrates a control method using an operational quadrant for operating the electrified vehicle of FIG. 1 module according to various principles of the present application.

### DESCRIPTION

As discussed above, in some electrified vehicles directed toward high performance, due to typically low volumes, it can be cost and time prohibitive to develop bespoke electric motors specifically suited to provide high output. Previous high-performance solutions incorporate two-motor setups (per axle) that provide higher powered motors or specifically designed bespoke configurations. Such solutions are high cost.

The instant disclosure provides a high-performance electrified vehicle having an electric drive axle that incorporates three electric motors and two geartrains. The three electric motors are independently driven and the two sets of geartrains are identical so as to be able to provide forward and reverse propulsion, dynamic torque vectoring, tank-turn/tank-steer capabilities and a variable gear reduction ratio (EVT) allowing high efficiency operation. The three electric motors and two geartrains can be off-the-shelf systems that are configured according to the instant disclosure to provide high-performance at lower cost.

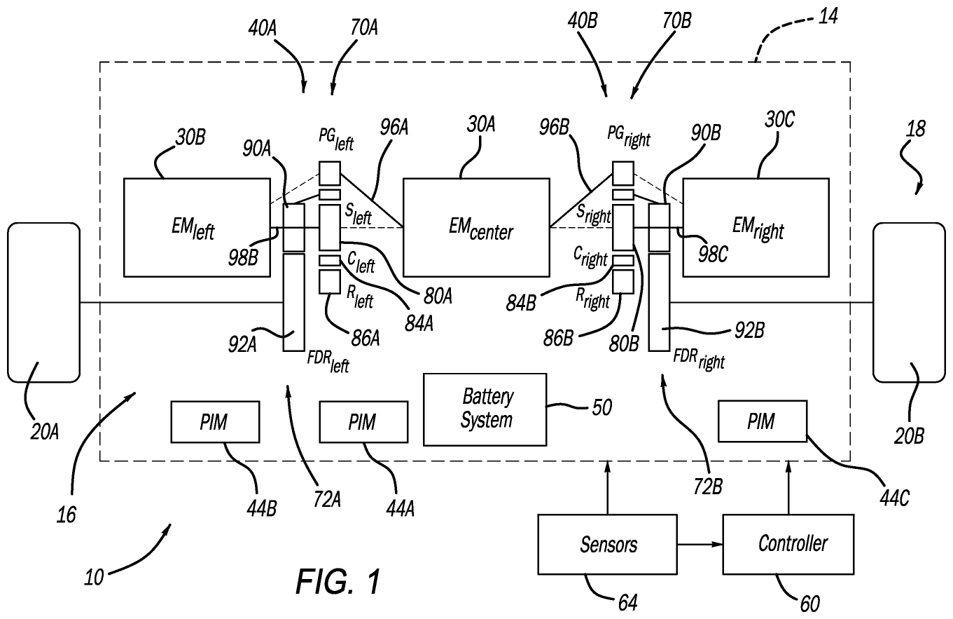

Referring now to FIG. 1, a functional block diagram of an example electrified vehicle 10 (also referred to herein as “vehicle 100”) according to the principles of the present application is illustrated. The vehicle 10 includes an electrified powertrain 14 having an electric drive module (EDM) or electric drive axle 16 configured to generate and transfer drive torque to a driveline 18 including drive wheels 20A, 20B for vehicle propulsion. The electric drive axle 16 generally includes three electric drive motors 30A, 30B and 30C (e.g., electric traction motors), two geartrains 40A, 40B, and power electronics including a power inverter module (PIM) 44A, 44B and 44C associated with each of the respective drive motors 30A, 30B and 30C. In some examples all three electric drive motors 30A, 30B and 30C can be similarly constructed. In other examples, the center drive motor 30A can be constructed differently than the outboard motors 30B and 30C.

The electric motors 30A, 30B and 30C are selectively connectable via the respective PIM's 44A-44C to a high voltage battery system 50 for powering the electric motor 30A, 30B and 30C. The battery system 50 is selectively connectable (e.g., by the driver) to an external charging system (not shown) for charging of the battery system 50. The battery system 50 includes at least one battery pack assembly. A controller 60 can provide various inputs to the electric drive axle 16 related to individual motor torque and speed targets or selectively switching power inputs between the electric motors 30A, 30B and 30C. As described herein, the controller 60 can base the inputs sent to the electric motors 30A, 30B and 30C according to signals received from sensors 64 related to various operating conditions (steering inputs, wheel speeds, acceleration inputs, etc.).

Additional features of the electric drive axle 16 will be further described. The first geartrain 40A includes a first or left planetary gearset (PG) 70A and a first final drive gear reduction (FDR) 72A. The second geartrain 40B includes a second or right PG 70B and a second FDR 72B. The first PG 70A includes a first sun gear 80A, a first carrier 84A and a first ring gear 86A. The second PG 70B includes a second sun gear 80B, a second carrier 84B and a second ring gear 86B.

The sun gears 80A and 80B are drivingly coupled to the first (left) and third (right) electric drive motors 30B and 30C, respectively. The ring gears 86A and 86B are drivingly coupled to respective first outputs 96A, 96B of the second (center) electric drive motor 30A. The carriers 84A and 84B are respectively connected to final drive pinions 90A and 90B which are floating on respective rotor output shafts 98B and 98C of the electric motors 30B and 30C. The FDR's 72A and 72B include ring gears 92A and 92B, respectively that are drivingly coupled to the corresponding drive wheels 20A and 20B to provide drive torque. In alternate configurations, the first and second FDR's 72A and 72B can include open or limited slip differentials housed within the rotor of the electric motor 30A connecting the rotor toque output to the ring gears 86A and 86B. In other configurations, additional gear reduction stages can be provided via external parallel-axis gears or planetary gears to achieve the optimum ratios/performance and packaging constraints.

By way of example only, the first, second and third electric motors 30A, 30B and 30C can be 350 KW (800V) electric motors. When configured in the arrangement disclosed herein, such readily available electric motors can collectively provide 1 megawatt (MW) propulsive power required for a high-performance electrified vehicle. It is appreciated that the electric motors can be configured differently having other kilowatt and voltage operating ranges according to application. Moreover, the instant configuration provides torque vectoring and precise control of high-speed cornering. Furthermore, the three electric motor configuration can also be used at low speeds for tank-turn or tank-steer applications. The instant application achieves a balance in cost, time-to-market and development effort by utilizing the three adequately powered electric motors and unique gearing to achieve the required propulsion functional objectives for a high-performance electrified vehicle. The configuration disclosed herein allows variable ratio enabling better performance and efficiency, allows torque vectoring (independent control of torque and speed for left and right drive wheels 20A, 20B) enabling cornering capability, allows tank turn/steer enabling off-road and low speed maneuvers and is lower cost than two high output electric motor configurations.

It is appreciated that the configuration shown in FIG. 1 is exemplary and some components can be fixed for rotation with other components. For example, the first motor 30A and the second and third motors 30B, 30C can be swapped in terms of which is coupled to the sun gear 80A, 80B and the ring gear 86A, 86B. See dashed lines represented in FIG. 1 for alternate configuration. Moreover, additional gearing may be incorporated for providing additional drive ratio advantages. In other arrangements, the first and second PG's 70A, 70B can be constructed differently. For example, one of the PG 70A, 70B can be configured with a higher ratio than the other PG. In such configurations it is contemplated that motor performance can be adjusted to accommodate the different ratios.

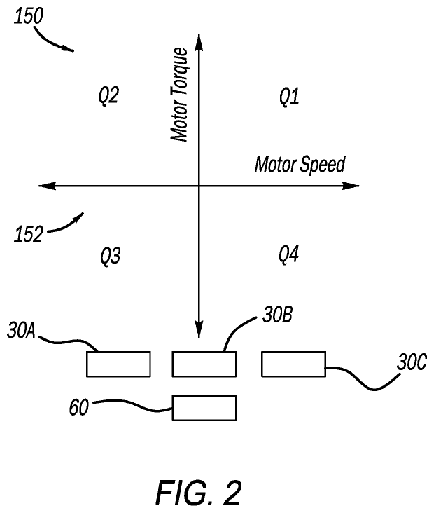

With continued reference to FIG. 1 and additional reference to FIG. 2, a control method of operating the electric motors 30A, 30B and 30C is shown and generally identified at reference 150. The method 150 provides potential modes of operation for operating the electrified powertrain 14 using the controller 60. In general, the potential modes correspond to operating the electric motors 30A, 30B and 30C in quadrants 152 that represent positive and negative motor torque and motor speed. Q1 represents a positive motor speed and positive motor torque, Q2 represents a negative motor speed and a positive motor torque; Q3 represents a negative motor speed and a negative motor torque; and Q4 represents a positive motor speed and a negative motor torque. The exemplary modes include: Mode 1, straight line driving with heavy acceleration; Mode 2, straight line driving with low or steady state acceleration; Mode 3, straight line driving with high-speed torque vectoring; Mode 4, steering left/right with regular turns versus high gravity turns; Mode 5, braking or regeneration mode; Mode 6, valet mode; and Mode 7, tank steer mode.

Mode 1 will now be described in greater detail. All three motors 30A, 30B and 30C are operating in Q1 at best possible torque constrained by discharge power of the battery system 50, traction available at the drive wheels 20A, 20B and thermal limits of the PIM 44. If all three electric motors 30A, 30B and 30C are identical, the gear ratio varies from medium—high—medium—low. If the center motor 30A is not identical to the left and right motor 30B and 30C, the gear ratio trend depends on torque and maximum revolutions per minute characteristics of all three motors 30A, 30B and 30C. Even if heavy acceleration is not desired, Mode 1 provides the most degrees of freedom to control and operate the electrified powertrain 14 most efficiently.

Mode 2 will now be described in greater detail. Mode 2 can include two versions. In Mode 2a, only the center motor 30A is operating in Q1. In Mode 2b, both outboard motors 30B and 30C are operating in Q1. As desired vehicle speeds, loads, grades or accelerations increase control may transition from Mode 2a to Mode 2b to attain best efficiency and torque reserve. In examples, control includes lookup tables that output the most efficient operating scenario for the given conditions. Mode 2a and 2b can each have a fixed gear ratio where Mode 2a=(Nₛ+Nₐ)/Nₐ×FDR. Mode 2b=(Nₛ+Nₐ)/Nₛ×FDR. In examples, Mode 2a can be constrained by back EMF and thermal limits for the outboard motors 30B, 30C. A clutching element can be disposed between the outboard motor 30B and sun gear 80A. Similarly, a clutching element can be disposed between the outboard motor 30C and sun gear 80B. The clutching element can be housed inside the center cavity of the rotor.

Mode 3 will now be described in greater detail. A baseline straight line driving occurring in any of Mode 1 or Mode 2b is initiated. When control determines an unequal traction is sensed between the drive wheels 20A and 20B, torque command is reduced at the motor 30B, 30C associated with the slipping drive wheel 20A, 20B. In examples, the controller 60 can receive signals from the sensors 64, such as wheel speeds associated with the drive wheels 20A, 20B. Based on a difference in wheel speeds, the controller 60 can command the motor associated with the slipping drive wheel to reduce torque. By way of example, if the controller 60 determines that the drive wheel 20A is slipping relative to drive wheel 20B, control commands the motor 30B to reduce or eliminate torque output until the slip or vehicle yaw-rate is controlled. Concurrently, the controller 60 can command the center motor 30A and right motor 30C to increase torque output. Similarly, if the controller 60 determines that the drive wheel 20B is slipping relative to drive wheel 20A, control commands the motor 300 to reduce or eliminate torque output until the slip or vehicle yaw-rate is controlled. Concurrently, the controller 60 can command the center motor 30A and left motor 30B to increase torque output. Control enables seamless straight-line motion and transitions over stretches of inconsistent available traction.

Mode 4 will now be described in greater detail. In examples while turning left and in either Mode 1 or Mode 2b, the controller 60 can command the left and center motors 30B and 30A to reduce torque output while commanding the right motor 30C to maintain or increase torque output. In other words, higher torque is maintained on the right motor 30C while turning left. In examples while turning left and in Mode 2a, the right motor 30C goes from zero torque to positive torque and higher speed. The left motor 30B freewheels. In examples while turning right and in either Mode 1 or Mode 2b, the controller 60 can command the right and center motors 30C and 30A to reduce torque output while commanding the left motor 30B to maintain or increase torque output. In other words, higher torque is maintained on the left motor 30B while turning right. In examples while turning right and in Mode 2a, the left motor 30B goes from zero torque to positive torque and higher speed. The right motor 30C freewheels.

Mode 5 will now be described in greater detail. During low braking or deceleration, the motors 30A, 30B and 30C in operation switch from Q1 to Q4. While operating in heavy braking or deceleration, the motors 30A, 30B and 30C operate in Q4.

Mode 6 will now be described in greater detail. While operating in two-wheel drive, control locks Mode 2a if the electrified vehicle 10 has only one drive axle. Speed and acceleration limits can be imposed. While operating in four-wheel drive (the electrified vehicle 10 has two separate drive axles 16), the rear axle can be turned off. The front drive axle can be locked in Mode 2a.

Mode 7 will now be described in greater detail. To turn clockwise in a four-wheel drive vehicle, the left motor 30B operates in Q1, the right motor 30C operates in Q3 and the center motor 30A can be locked at zero speed (stall condition), or input current to the center motor 30A is cut. The same concept applies to a two-wheel drive vehicle, except in some circumstances the secondary axle can experience tire scrub due to lateral forces.

In some implementations the design of the three electric motor configurations can be modular. For example, an axle can be built as needed. In one example, a single motor only axle can be provided using the motor 30A. In another example, a two motor only axle can be provided using the motors 30B and 30C. In yet another example, the three motor configuration described above using all motors 30A-30C can be constructed.

As used herein, the term controller or module refers to an application specific integrated circuit (ASIC), an electronic circuit, a processor (shared, dedicated, or group) and memory that executes one or more software or firmware programs, a combinational logic circuit, and/or other suitable components that provide the described functionality.

It will be understood that the mixing and matching of features, elements, methodologies, systems and/or functions between various examples may be expressly contemplated herein so that one skilled in the art will appreciate from the present teachings that features, elements, systems and/or functions of one example may be incorporated into another example as appropriate, unless described otherwise above. It will also be understood that the description, including disclosed examples and drawings, is merely exemplary in nature intended for purposes of illustration only and is not intended to limit the scope of the present application, its application or uses. Thus, variations that do not depart from the gist of the present application are intended to be within the scope of the present application.

What is claimed is:

1. An electrified powertrain that generates and transfers drive torque to a driveline of an electrified vehicle including first and second drive wheels, the electrified powertrain comprising:
an electric drive module comprising:
a first electric motor having two first outputs;
a second electric motor having a second output;
a third electric motor having a third output;
a first geartrain including:
a first planetary gear set having a first sun gear fixed for rotation with the second output, a first carrier, and a first ring gear fixed for rotation with one of the first outputs; and
a first final gear reduction having a first final drive pinion fixed for rotation with the first carrier and a first final output that drives the first drive wheel; and
a second geartrain including:
a second planetary gear set having a second sun gear fixed for rotation with the third output, a second carrier, and a second ring gear fixed for rotation with the other of the first outputs; and
a second final gear reduction having a second final drive pinion fixed for rotation with the second carrier and a second final output that drives the second drive wheel.

2. The electrified powertrain of claim 1, further comprising:
a controller that controls operation of the first, second and third electric motors to alter drive torque to the driveline based on operating conditions.

3. The electrified powertrain of claim 2, wherein the controller is configured to operate the electric drive module in a first straight line driving mode including:
command only the first electric motor to operate in positive motor torque and positive motor speed.

4. The electrified powertrain of claim 3, wherein the controller is configured to operate the electric drive module in a second straight line driving mode including:
command only the second and third electric motors to operate in positive motor torque and positive motor speed.

5. The electrified powertrain of claim 4, wherein the controller is configured to transition operation of the electric drive module between the first and second straight line driving mode based on operating conditions.

6. The electrified powertrain of claim 2, wherein the controller is configured to operate the electric drive module in a torque vectoring mode including:
determine one of the first or second drive wheels slipping; and
command the electric motor associated with the slipping drive wheel to operate at a reduced torque.

7. The electrified powertrain of claim 2, wherein the controller is configured to operate the electric drive module in a steering mode including:
determine a steering input to a left direction;
command the first and second electric motors to reduce speed; and
command the third electric motor to increase speed.

8. The electrified powertrain of claim 7, wherein the controller is further configured to:
determine a steering input to a right direction;
command the first and third electric motors to reduce speed; and
command the second electric motor to increase speed.

9. The electrified powertrain of claim 6, wherein the controller is further configured to operate the electric drive module in a braking mode including:
command the first, second and third motors to change operation from positive motor speed and positive motor torque to positive motor speed and negative motor torque.

10. The electrified powertrain of claim 6, wherein the controller is further configured to operate the electric drive module in a tank steer mode including:
command the second motor to operate in positive motor speed and positive motor torque;
command the third motor to operate in a negative motor speed and negative motor torque; and
command the first motor to operate at zero speed.

11. The electrified powertrain of claim 1, wherein the first final drive pinion is floating on the second output shaft and the second final drive pinion is floating on the third output shaft.

12. The electrified powertrain of claim 1, wherein the first electric motor is positioned intermediate the second and third electric motors.

13. The electrified powertrain of claim 12, wherein the first, second and third electric motors are constructed similarly.

14. The electrified powertrain of claim 13, wherein the first, second and third electric motors comprise 350 KW electric motors.

15. The electrified powertrain of claim 1, wherein the first electric motor is constructed differently than the second and third electric motors.

16. An electrified powertrain that generates and transfers drive torque to a driveline of an electrified vehicle including first and second drive wheels, the electrified powertrain comprising:
an electric drive module comprising:
a first electric motor having two first outputs;
a second electric motor having a second output;
a third electric motor having a third output;
a first geartrain including:
a first planetary gear set having a first sun gear fixed for rotation with one of the first outputs, a first carrier, and a first ring gear fixed for rotation with the second output; and
a first final gear reduction having a first final drive pinion fixed for rotation with the first carrier and a first final output that drives the first drive wheel; and
a second geartrain including:
a second planetary gear set having a second sun gear fixed for rotation with the other of the first outputs, a second carrier, and a second ring gear fixed for rotation with the third output; and
a second final gear reduction having a second final drive pinion fixed for rotation with the second carrier and a second final output that drives the second drive wheel.
